(19) United States
(12) Patent Application Publication
(10) Pub. No.: US 2021/0392109 A1
(43) Pub. Date: Dec. 16, 2021

(54) DETECTION DEVICE, GATEWAY DEVICE, DETECTION METHOD, AND DETECTION PROGRAM

(71) Applicants: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(72) Inventors: Yoshihiro HAMADA, Osaka-shi (JP); Keigo YOSHIDA, Osaka-shi (JP); Hiroshi UEDA, Yokkaichi-shi (JP); Naoki ADACHI, Yokkaichi-shi (JP); Shinichi AIBA, Yokkaichi-shi (JP)

(73) Assignees: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(21) Appl. No.: 17/283,638

(22) PCT Filed: May 16, 2019
(86) PCT No.: PCT/JP2019/019551

§ 371 Date: Apr. 8, 2021

(30) Foreign Application Priority Data
Oct. 18, 2018 (JP) 2018-196635

(51) Int. Cl. H04L 29/06

(52) U.S. Cl. CPC H04L 63/0209; H04W 4/48; H04L 63/1416

(57) ABSTRACT

A detection device is configured to detect an unauthorized message in an on-vehicle network including a plurality of on-vehicle devices. The detection device includes: a monitoring unit configured to monitor transmission messages in the on-vehicle network and configured to create first time series data being time series data of values of transmission intervals of the transmission messages in a first period and second time series data being time series data of values of transmission intervals of the transmission messages in a second period; a correlation calculation unit configured to calculate a correlation between the first time series data and the second time series data that have been created by the monitoring unit; and a detection unit configured to detect the unauthorized message on the basis of the correlation calculated by the correlation calculation unit.

### TECHNICAL FIELD

The present invention relates to a detection device, a gateway device, a detection method, and a detection program.

This application claims priority on Japanese Patent Application No. 2018-196635 filed on Oct. 18, 2018, the entire content of which is incorporated herein by reference.

### BACKGROUND ART

PATENT LITERATURE 1 (International Publication No. WO2015/170451) discloses an on-vehicle network system as below. That is, the on-vehicle network system is an on-vehicle network system including a plurality of electronic control units that communicate with one another via a bus in accordance with a CAN (Controller Area Network) protocol, the system comprising: a first electronic control unit including a providing unit that provides, when a data frame that does not follow a predetermined rule for a transmission cycle is transmitted, a specific identifier in the data frame, and a transmitting unit that transmits, via the bus, a data frame that includes the specific identifier provided by the providing unit and that does not follow the predetermined rule; and a second electronic control unit including a receiving unit that receives a data frame transmitted on the bus, and a verifying unit that verifies, when a data frame that does not follow the predetermined rule is received by the receiving unit, the specific identifier in the data frame.

### CITATION LIST

### Patent Literature

PATENT LITERATURE 1: International Publication No. WO2015/170451

PATENT LITERATURE 2: Japanese Laid-Open Patent Publication No. 2017-126978

### SUMMARY OF INVENTION

(1) A detection device of the present disclosure is configured to detect an unauthorized message in an on-vehicle network including a plurality of on-vehicle devices. The detection device includes: a monitoring unit configured to monitor transmission messages in the on-vehicle network and configured to create first time series data being time series data of values of transmission intervals of the transmission messages in a first period and second time series data being time series data of values of transmission intervals of the transmission messages in a second period; a correlation calculation unit configured to calculate a correlation between the first time series data and the second time series data that have been created by the monitoring unit; and a detection unit configured to detect the unauthorized message on the basis of the correlation calculated by the correlation calculation unit.

(4) A gateway device of the present disclosure is configured to relay messages between on-vehicle devices in an on-vehicle network. The gateway device includes: a monitoring unit configured to monitor transmission messages in the on-vehicle network and configured to create first time series data being time series data of values of transmission intervals of the transmission messages in a first period and second time series data being time series data of values of transmission intervals of the transmission messages in a second period; a correlation calculation unit configured to calculate a correlation between the first time series data and the second time series data that have been created by the monitoring unit; and a detection unit configured to detect an unauthorized message in the on-vehicle network on the basis of the correlation calculated by the correlation calculation unit.

(5) A detection method of the present disclosure is to be performed in a detection device configured to detect an unauthorized message in an on-vehicle network including a plurality of on-vehicle devices. The detection method includes the steps of: monitoring transmission messages in the on-vehicle network and creating first time series data being time series data of values of transmission intervals of the transmission messages in a first period and second time series data being time series data of values of transmission intervals of the transmission messages in a second period; calculating a correlation between the first time series data and the second time series data that have been created; and detecting the unauthorized message on the basis of the calculated correlation.

(6) A detection method of the present disclosure is to be performed in a gateway device configured to relay messages between on-vehicle devices in an on-vehicle network. The detection method includes the steps of: monitoring transmission messages in the on-vehicle network and creating first time series data being time series data of values of transmission intervals of the transmission messages in a first period and second time series data being time series data of values of transmission intervals of the transmission messages in a second period; calculating a correlation between the first time series data and the second time series data that have been created; and detecting an unauthorized message in the on-vehicle network on the basis of the calculated correlation.

(7) A detection program of the present disclosure is to be used in a detection device configured to detect an unauthorized message in an on-vehicle network including a plurality of on-vehicle devices. The detection program causes a computer to function as: a monitoring unit configured to monitor transmission messages in the on-vehicle network, and configured to create first time series data being time series data of values of transmission intervals of the transmission messages in a first period and second time series data being time series data of values of transmission intervals of the transmission messages in a second period; a correlation calculation unit configured to calculate a correlation between the first time series data and the second time series data that have been created by the monitoring unit; and a detection unit configured to detect the unauthorized message on the basis of the correlation calculated by the correlation calculation unit.

(8) A detection program of the present disclosure is to be used in a gateway device configured to relay messages between on-vehicle devices in an on-vehicle network. The detection program causes a computer to function as: a monitoring unit configured to monitor transmission messages in the on-vehicle network and configured to create first time series data being time series data of values of transmission intervals of the transmission messages in a first period and second time series data being time series data of values of transmission intervals of the transmission messages in a second period; a correlation calculation unit configured to calculate a correlation between the first time series data and the second time series data that have been created by the monitoring unit; and a detection unit configured to detect an unauthorized message in the on-vehicle network on the basis of the correlation calculated by the correlation calculation unit.

One mode of the present disclosure can be realized not only as a detection device including such a characteristic processing unit but also as an on-vehicle communication system including the detection device. One mode of the present disclosure can be realized as a semiconductor integrated circuit that realizes a part or the entirety of the detection device.

One mode of the present disclosure can be realized not only as a gateway device including such a characteristic processing unit but also as an on-vehicle communication system including the gateway device. One mode of the present disclosure can be realized as a semiconductor integrated circuit that realizes a part or the entirety of the gateway device.

### BRIEF DESCRIPTION OF DRAWINGS

FIG. 1 shows a configuration of an on-vehicle communication network according to an embodiment of the present disclosure.

FIG. 2 shows a configuration of a bus connection device group according to the embodiment of the present disclosure.

FIG. 3 shows an example of temporal change in the transmission interval of event messages in an on-vehicle communication system according to the embodiment of the present disclosure.

FIG. 4 shows an example of a frequency distribution of the transmission interval of event messages in the on-vehicle communication system according to the embodiment of the present disclosure.

FIG. 5 shows a configuration of a gateway device in the on-vehicle communication system according to the embodiment of the present disclosure.

FIG. 6 shows an example of a distribution of reception times of target messages in the on-vehicle communication system according to the embodiment of the present disclosure.

FIG. 7 shows an example of time series data of the transmission intervals of target messages in the on-vehicle communication system according to the embodiment of the present disclosure.

FIG. 8 shows an example of time series data of the transmission intervals of target messages in the on-vehicle communication system according to the embodiment of the present disclosure.

FIG. 9 shows an example of time series data having been subjected to a sign reversing process in the on-vehicle communication system according to the embodiment of the present disclosure.

FIG. 10 shows an example of time series data having been subjected to the sign reversing process in the on-vehicle communication system according to the embodiment of the present disclosure.

FIG. 11 shows an example of a frequency distribution of an autocorrelation coefficient of the transmission interval in the on-vehicle communication system according to the embodiment of the present disclosure.

FIG. 12 shows an evaluation model used in evaluation of a detection method for an unauthorized message in the on-vehicle communication system according to the embodiment of the present disclosure.

FIG. 13 shows an evaluation result of sensitivity of the detection method for an unauthorized message in the on-vehicle communication system according to the embodiment of the present disclosure.

FIG. 14 shows a configuration of devices in the on-vehicle communication system according to the embodiment of the present disclosure.

FIG. 15 is a flow chart describing an operation procedure according to which the gateway device of the embodiment of the present disclosure performs detection of an unauthorized message.

FIG. 16 shows an example of a connection topology of an on-vehicle network according to the embodiment of the present disclosure.

### DESCRIPTION OF EMBODIMENTS

To date, on-vehicle network systems for improving security in on-vehicle networks have been developed.

### Problems to be Solved by the Present Disclosure

PATENT LITERATURE 1 indicates that, according to the on-vehicle network system, when a data frame of which a transmission cycle does not satisfy a condition, i.e., an event-driven data frame, has been received, validity thereof can be determined through verification of the specific identifier, whereby an unauthorized data frame can be appropriately detected.

However, in the on-vehicle network system described in PATENT LITERATURE 1, in order to detect an unauthorized data frame on the basis of the specific identifier, a providing unit that provides the specific identifier to an event-driven data frame is required in the transmission-side electronic control unit, and a verifying unit that verifies the specific identifier is required in the reception-side electronic control unit. This results in a complicated configuration of the on-vehicle network system.

The present disclosure has been made in order to solve the above problem. An object of the present disclosure is to provide a detection device, a gateway device, a detection method, and a detection program that can accurately detect an unauthorized message in an on-vehicle network, with a simple configuration.

### Effects of the Present Disclosure

According to the present disclosure, an unauthorized message in an on-vehicle network can be accurately detected with a simple configuration.

### Description of Embodiment of the Present Disclosure

First, contents of an embodiment of the present disclosure are listed and described.

(1) A detection device according to an embodiment of the present disclosure is configured to detect an unauthorized message in an on-vehicle network including a plurality of on-vehicle devices. The detection device includes: a monitoring unit configured to monitor transmission messages in the on-vehicle network and configured to create first time series data being time series data of values of transmission intervals of the transmission messages in a first period and second time series data being time series data of values of transmission intervals of the transmission messages in a second period; a correlation calculation unit configured to calculate a correlation between the first time series data and the second time series data that have been created by the monitoring unit; and a detection unit configured to detect the unauthorized message on the basis of the correlation calculated by the correlation calculation unit.

For example, when the transmission messages in the first period and the second period are authorized messages that are non-periodically transmitted, the correlation between the first time series data and the second time series data is low. Meanwhile, when an unauthorized message that is periodically transmitted is present among the transmission messages in the first period and the second period, periodicity of the transmission messages is increased, and thus, the correlation between the first time series data and the second time series data is increased. In the case of the detection device according to the embodiment of the present disclosure, the correlation between the first time series data and the second time series data is focused on, and an unauthorized message is detected on the basis of the correlation. Therefore, when compared with a configuration in which an unauthorized message is detected on the basis of the reception frequency of messages, an unauthorized message mixed among non-periodically transmitted authorized messages can be accurately detected. Therefore, an unauthorized message in the on-vehicle network can be accurately detected with a simple configuration.

(2) Preferably, the monitoring unit creates the first time series data and the second time series data in each of which a positive/negative sign of the value of each transmission interval is alternately reversed along time series, and the correlation calculation unit calculates the correlation by using a difference between the value of each transmission interval and an average value of the values of the transmission intervals in the first time series data created by the monitoring unit, and a difference between the value of each transmission interval and an average value of the values of the transmission intervals in the second time series data created by the monitoring unit.

When unauthorized messages are periodically transmitted at a high frequency, the value of each transmission interval of the transmission messages becomes close to an equal interval, whereby the difference between the value of each transmission interval and the average value of the values of the transmission intervals is decreased. As a result, it may become difficult to accurately calculate, in a CPU or the like, correlation between the first time series data and the second time series data. In contrast, in a configuration in which the first time series data and the second time series data in each of which the positive/negative sign of the value of each transmission interval is alternately reversed along time series, are created, and the difference between the value of each transmission interval and the average value of the values of the transmission intervals of the first time series data, and the difference between the value of each transmission interval and the average value of values of the transmission intervals of the second time series data are used to calculate a correlation, the correlation between the first time series data and the second time series data can be accurately calculated even when unauthorized messages are periodically transmitted at a high frequency. Accordingly, an unauthorized message can be detected with high accuracy on the basis of the correlation.

(3) More preferably, the detection unit determines that the unauthorized message is present among the corresponding transmission messages, when the correlation calculated by the correlation calculation unit is smaller than a first threshold being a negative number greater than −1, or is greater than a second threshold being a positive number smaller than 1.

With this configuration, for example, an unauthorized message can be accurately detected on the basis of the correlation calculated by the correlation calculation unit, and the first threshold and the second threshold set to appropriate values in advance. In addition, for example, an unauthorized message can be accurately detected on the basis of the correlation calculated by use of the first time series data and the second time series data in each of which the positive/negative sign of the value of each transmission interval is alternately reversed along time series, and the first threshold and the second threshold set to appropriate values in advance.

(4) A gateway device according to the embodiment of the present disclosure is configured to relay messages between on-vehicle devices in an on-vehicle network. The gateway device includes: a monitoring unit configured to monitor transmission messages in the on-vehicle network and configured to create first time series data being time series data of values of transmission intervals of the transmission messages in a first period and second time series data being time series data of values of transmission intervals of the transmission messages in a second period; a correlation calculation unit configured to calculate a correlation between the first time series data and the second time series data that have been created by the monitoring unit; and a detection unit configured to detect an unauthorized message in the on-vehicle network on the basis of the correlation calculated by the correlation calculation unit.

For example, when the transmission messages in the first period and the second period are authorized messages that are non-periodically transmitted, the correlation between the first time series data and the second time series data is low. Meanwhile, when an unauthorized message that is periodically transmitted is present among the transmission messages in the first period and the second period, periodicity of the transmission messages is increased, and thus, the correlation between the first time series data and the second time series data is increased. In the case of the gateway device according to the embodiment of the present disclosure, the correlation between the first time series data and the second time series data is focused on, and an unauthorized message is detected on the basis of the correlation. Therefore, when compared with a configuration in which an unauthorized message is detected on the basis of the reception frequency of messages, an unauthorized message mixed among non-periodically transmitted authorized messages can be accurately detected. Therefore, an unauthorized message in the on-vehicle network can be accurately detected with a simple configuration.

(5) A detection method according to the embodiment of the present disclosure is to be performed in a detection device configured to detect an unauthorized message in an on-vehicle network including a plurality of on-vehicle devices. The detection method includes the steps of: monitoring transmission messages in the on-vehicle network and creating first time series data being time series data of values of transmission intervals of the transmission messages in a first period and second time series data being time series data of values of transmission intervals of the transmission messages in a second period; calculating a correlation between the first time series data and the second time series data that have been created; and detecting the unauthorized message on the basis of the calculated correlation.

For example, when the transmission messages in the first period and the second period are authorized messages that are non-periodically transmitted, the correlation between the first time series data and the second time series data is low. Meanwhile, when an unauthorized message that is periodically transmitted is present among the transmission messages in the first period and the second period, periodicity of the transmission messages is increased, and thus, the correlation between the first time series data and the second time series data is increased. In the case of the detection method according to the embodiment of the present disclosure, the correlation between the first time series data and the second time series data is focused on, and an unauthorized message is detected on the basis of the correlation. Therefore, when compared with a method in which an unauthorized message is detected on the basis of the reception frequency of messages, an unauthorized message mixed among non-periodically transmitted authorized messages can be accurately detected. Therefore, an unauthorized message in the on-vehicle network can be accurately detected with a simple configuration.

(6) A detection method according to the embodiment of the present disclosure is to be performed in a gateway device configured to relay messages between on-vehicle devices in an on-vehicle network. The detection method includes the steps of: monitoring transmission messages in the on-vehicle network and creating first time series data being time series data of values of transmission intervals of the transmission messages in a first period and second time series data being time series data of values of transmission intervals of the transmission messages in a second period; calculating a correlation between the first time series data and the second time series data that have been created; and detecting an unauthorized message in the on-vehicle network on the basis of the calculated correlation.

For example, when the transmission messages in the first period and the second period are authorized messages that are non-periodically transmitted, the correlation between the first time series data and the second time series data is low. Meanwhile, when an unauthorized message that is periodically transmitted is present among the transmission messages in the first period and the second period, periodicity of the transmission messages is increased, and thus, the correlation between the first time series data and the second time series data is increased. In the case of the detection method according to the embodiment of the present disclosure, the correlation between the first time series data and the second time series data is focused on, and an unauthorized message is detected on the basis of the correlation. Therefore, when compared with a method in which an unauthorized message is detected on the basis of the reception frequency of messages, an unauthorized message mixed among non-periodically transmitted authorized messages can be accurately detected. Therefore, an unauthorized message in the on-vehicle network can be accurately detected with a simple configuration.

(7) A detection program according to the embodiment of the present disclosure is to be used in a detection device configured to detect an unauthorized message in an on-vehicle network including a plurality of on-vehicle devices. The detection program causes a computer to function as: a monitoring unit configured to monitor transmission messages in the on-vehicle network, and configured to create first time series data being time series data of values of transmission intervals of the transmission messages in a first period and second time series data being time series data of values of transmission intervals of the transmission messages in a second period; a correlation calculation unit configured to calculate a correlation between the first time series data and the second time series data that have been created by the monitoring unit; and a detection unit configured to detect the unauthorized message on the basis of the correlation calculated by the correlation calculation unit.

For example, when the transmission messages in the first period and the second period are authorized messages that are non-periodically transmitted, the correlation between the first time series data and the second time series data is low. Meanwhile, when an unauthorized message that is periodically transmitted is present among the transmission messages in the first period and the second period, periodicity of the transmission messages is increased, and thus, the correlation between the first time series data and the second time series data is increased. In the case of the detection program according to the embodiment of the present disclosure, the correlation between the first time series data and the second time series data is focused on, and an unauthorized message is detected on the basis of the correlation. Therefore, when compared with a configuration in which an unauthorized message is detected on the basis of the reception frequency of messages, an unauthorized message mixed among non-periodically transmitted authorized messages can be accurately detected. Therefore, an unauthorized message in the on-vehicle network can be accurately detected with a simple configuration.

(8) A detection program according to the embodiment of the present disclosure is to be used in a gateway device configured to relay messages between on-vehicle devices in an on-vehicle network. The detection program causes a computer to function as: a monitoring unit configured to monitor transmission messages in the on-vehicle network and configured to create first time series data being time series data of values of transmission intervals of the transmission messages in a first period and second time series data being time series data of values of transmission intervals of the transmission messages in a second period; a correlation calculation unit configured to calculate a correlation between the first time series data and the second time series data that have been created by the monitoring unit; and a detection unit configured to detect an unauthorized message in the on-vehicle network on the basis of the correlation calculated by the correlation calculation unit.

For example, when the transmission messages in the first period and the second period are authorized messages that are non-periodically transmitted, the correlation between the first time series data and the second time series data is low. Meanwhile, when an unauthorized message that is periodically transmitted is present among the transmission messages in the first period and the second period, periodicity of the transmission messages is increased, and thus, the correlation between the first time series data and the second time series data is increased. In the case of the detection program according to the embodiment of the present disclosure, the correlation between the first time series data and the second time series data is focused on, and an unauthorized message is detected on the basis of the correlation. Therefore, when compared with a configuration in which an unauthorized message is detected on the basis of the reception frequency of messages, an unauthorized message mixed among non-periodically transmitted authorized messages can be accurately detected. Therefore, an unauthorized message in the on-vehicle network can be accurately detected with a simple configuration.

Hereinafter, an embodiment of the present disclosure is described with reference to the drawings. In the drawings, the same or corresponding parts are denoted by the same reference signs, and descriptions thereof are not repeated. At least some parts of the embodiment described below can be combined together as desired.

[Configuration and Basic Operation]

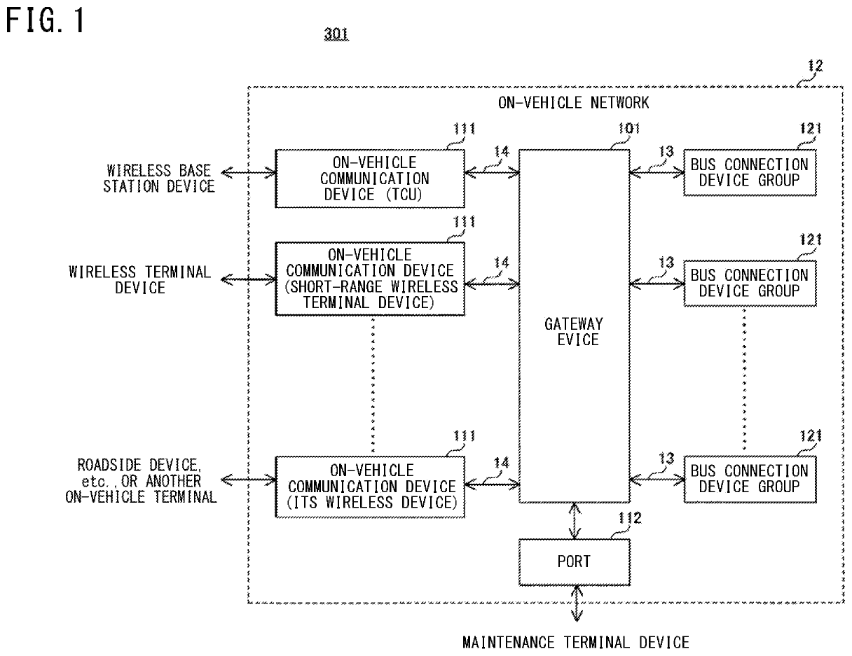

FIG. 1 shows a configuration of an on-vehicle communication network according to an embodiment of the present disclosure.

With reference to FIG. 1, an on-vehicle communication system 301 includes a gateway device (detection device) 101, a plurality of on-vehicle communication devices 111, and a plurality of bus connection device groups 121.

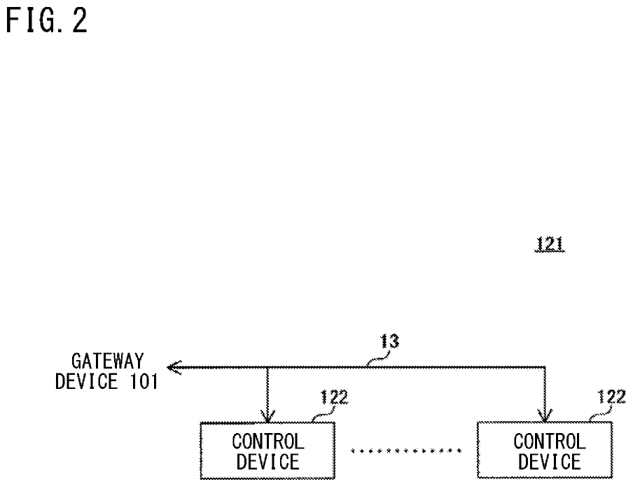

FIG. 2 shows a configuration of a bus connection device group according to the embodiment of the present disclosure.

With reference to FIG. 2, the bus connection device group 121 includes a plurality of control devices 122. The bus connection device group 121 need not necessarily include a plurality of control devices 122, and may include one control device 122.

The on-vehicle communication system 301 is mounted in a vehicle (hereinafter, also referred to as a target vehicle) which travels on a road. An on-vehicle network 12 includes a plurality of on-vehicle devices which are devices provided in the vehicle. Specifically, the on-vehicle network 12 includes a plurality of on-vehicle communication devices 111 and a plurality of control devices 122, which are examples of the on-vehicle devices. As long as the on-vehicle network 12 includes a plurality of on-vehicle devices, the on-vehicle network 12 may be configured to include a plurality of on-vehicle communication devices 111 and not to include any control device 122, may be configured not to include any on-vehicle communication device 111 and to include a plurality of control devices 122, or may be configured to include one on-vehicle communication device 111 and one control device 122.

In the on-vehicle network 12, the on-vehicle communication device 111 communicates with a device outside the target vehicle, for example. Specifically, the on-vehicle communication device 111 is a TCU (Telematics Communication Unit), a short-range wireless terminal device, or an ITS (Intelligent Transport Systems) wireless device, for example.

The TCU can perform wireless communication with a wireless base station device in accordance with a communication standard such as LTE (Long Term Evolution) or 3G, and can perform communication with the gateway device 101, for example. The TCU relays information to be used in services such as navigation, vehicle burglar prevention, remote maintenance, and FOTA (Firmware Over The Air), for example.

For example, the short-range wireless terminal device can perform wireless communication with a wireless terminal device such as a smartphone held by a person (hereinafter, also referred to as an occupant) in the target vehicle, in accordance with a communication standard such as Wi-Fi (registered trademark) and Bluetooth (registered trademark), and can perform communication with the gateway device 101. The short-range wireless terminal device relays information to be used in a service such as entertainment, for example.

For example, the short-range wireless terminal device can perform wireless communication with a wireless terminal device such as a smart key held by the occupant and with a wireless terminal device provided at a tire, in accordance with a predetermined communication standard by using a radio wave in an LF (Low Frequency) band or a UHF (Ultra High Frequency) band, and can perform communication with the gateway device 101. The short-range wireless terminal device relays information to be used in services such as smart entry and TPMS (Tire Pressure Monitoring System), for example.

The ITS wireless device can perform roadside-to-vehicle communication with a roadside device, such as an optical beacon, a radio wave beacon, or an ITS spot, provided in the vicinity of a road, can perform vehicle-to-vehicle communication with an on-vehicle terminal mounted in another vehicle, and can perform communication with the gateway device 101, for example. The ITS wireless device relays information to be used in services such as congestion alleviation, safe driving support, and route guidance, for example.

The gateway device 101 can, via a port 112, transmit/receive data for update or the like of firmware, and data, etc., accumulated by the gateway device 101 to/from a maintenance terminal device outside the target vehicle, for example.

The gateway device 101 is connected to on-vehicle devices via buses 13, 14, for example. Specifically, each bus 13, 14 is a bus according to, for example, a standard of CAN (Controller Area Network) (registered trademark), FlexRay (registered trademark), MOST (Media Oriented Systems Transport) (registered trademark), Ethernet (registered trademark), LIN (Local Interconnect Network), or the like.

In this example, each on-vehicle communication device 111 is connected to the gateway device 101 via a corresponding bus 14 according to the Ethernet standard. Each control device 122 in each bus connection device group 121 is connected to the gateway device 101 via a corresponding bus 13 according to the CAN standard. The control device 122 can control a function unit in the target vehicle, for example.

The buses 13 are provided for respective types of systems, for example. Specifically, the buses 13 are implemented as a drive-related bus, a chassis/safety-related bus, a body/electrical-equipment-related bus, and an AV/information-related bus, for example.

The drive-related bus has connected thereto an engine control device, an AT (Automatic Transmission) control device, and an HEV (Hybrid Electric Vehicle) control device, which are examples of the control device 122. The engine control device, the AT control device, and the HEV control device control an engine, AT, and switching between the engine and a motor, respectively.

The chassis/safety-related bus has connected thereto a brake control device, a chassis control device, and a steering control device, which are examples of the control device 122. The brake control device, the chassis control device, and the steering control device control a brake, a chassis, and steering, respectively.

The body/electrical-equipment-related bus has connected thereto an instrument indication control device, an air conditioner control device, a burglar prevention control device, an air bag control device, and a smart entry control device, which are examples of the control device 122. The instrument indication control device, the air conditioner control device, the burglar prevention control device, the air bag control device, and the smart entry control device control instruments, an air conditioner, a burglar prevention mechanism, an air bag mechanism, and smart entry, respectively.

The AV/information-related bus has connected thereto a navigation control device, an audio control device, an ETC (Electronic Toll Collection System) (registered trademark) control device, and a telephone control device, which are examples of the control device 122. The navigation control device, the audio control device, the ETC control device, and the telephone control device control a navigation device, an audio device, an ETC device, and a mobile phone, respectively.

The bus 13 need not necessarily have the control devices 122 connected thereto, and may have connected thereto a device other than the control devices 122.

The gateway device 101 is a central gateway (CGW), for example, and can perform communication with the on-vehicle devices.

The gateway device 101 performs a relay process of relaying information transmitted/received between control devices 122 that are connected to different buses 13 in the target vehicle, information transmitted/received between on-vehicle communication devices 111, and information transmitted/received between a control device 122 and an on-vehicle communication device 111, for example.

More specifically, in a target vehicle, for example, in order to make a notification of a non-periodic change in states, etc., of a door lock and a gear, a message is non-periodically transmitted from an on-vehicle device to another on-vehicle device. Specifically, in accordance with unlocking/locking of a door, gear change, operation of a direction indicator, or the like in the target vehicle, a message is non-periodically transmitted from an on-vehicle device to another on-vehicle device. Hereinafter, a message that is non-periodically transmitted will also be referred to as an event message.

Transmission of a message may be performed by broadcast or may be performed by unicast.

In the target vehicle, other than the event message, there is a message that is periodically transmitted from an on-vehicle device to another on-vehicle device in accordance with a predetermined rule.

In the following, the event message that is transmitted from a control device 122 to another control device 122 is described. However, the same also applies to an event message that is transmitted between a control device 122 and an on-vehicle communication device 111, and an event message that is transmitted between on-vehicle communication devices 111.

Each message includes an ID for identifying the content, transmission source, or the like of the message. Whether or not the message is an event message can be discerned by the ID.

[Problem]

Meanwhile, PATENT LITERATURE 2 (Japanese Laid-Open Patent Publication No. 2017-126978) discloses an abnormality detection method as below. That is, the abnormality detection method is an abnormality detection method for detecting an abnormality in an on-vehicle network system, the on-vehicle network system including a plurality of electronic control units that transmit and receive a message via a bus in a vehicle according to a CAN protocol. The abnormality detection method includes: determining a unit time period; and determining whether or not there is an abnormality in accordance with a result of an arithmetic process performed using feature information based on the number of messages received from the bus in the determined unit time period, and a predetermined model indicating a reference for a message occurrence frequency.

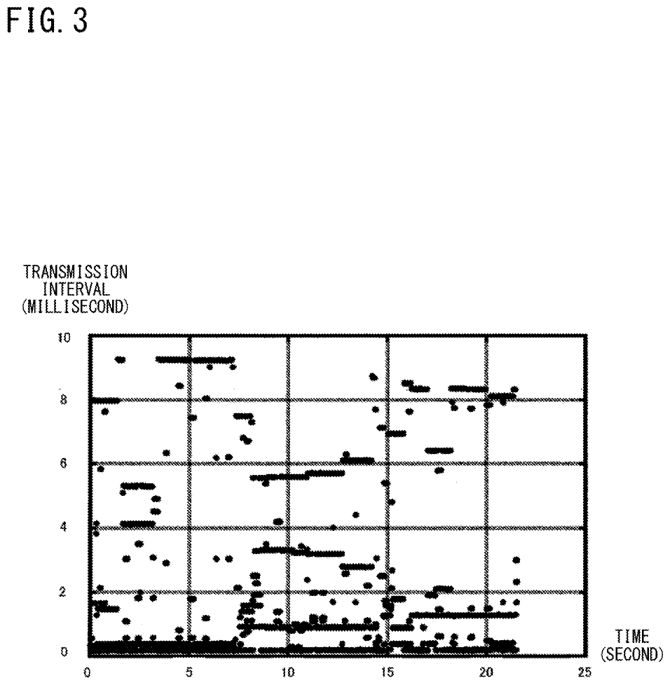

FIG. 3 shows an example of temporal change in the transmission interval of event messages in an on-vehicle communication system according to the embodiment of the present disclosure. In FIG. 3, the vertical axis represents transmission interval and the horizontal axis represents time.

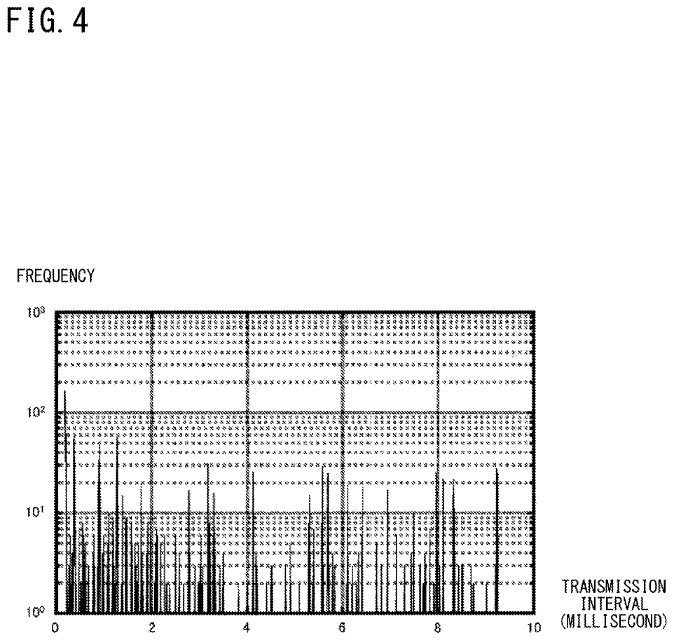

FIG. 4 shows an example of a frequency distribution of the transmission interval of event messages in the on-vehicle communication system according to the embodiment of the present disclosure. In FIG. 4, the vertical axis represents frequency and the horizontal axis represents transmission interval.

With reference to FIG. 3 and FIG. 4, the transmission interval is an interval between timings at which an event message is transmitted in a bus 13, for example.

As shown in FIG. 3 and FIG. 4, the value of the transmission interval of event messages is not constant and is varied. Here, an unauthorized message is mechanically and periodically transmitted in some cases. For example, in the abnormality detection method described in PATENT LITERATURE 2 and in an unauthorized-message detection method in which an abnormality is determined simply when the reception frequency of a message has exceeded a predetermined threshold, it is difficult to accurately detect a periodic unauthorized message that is mixed among event messages.

[Configuration of Gateway Device]

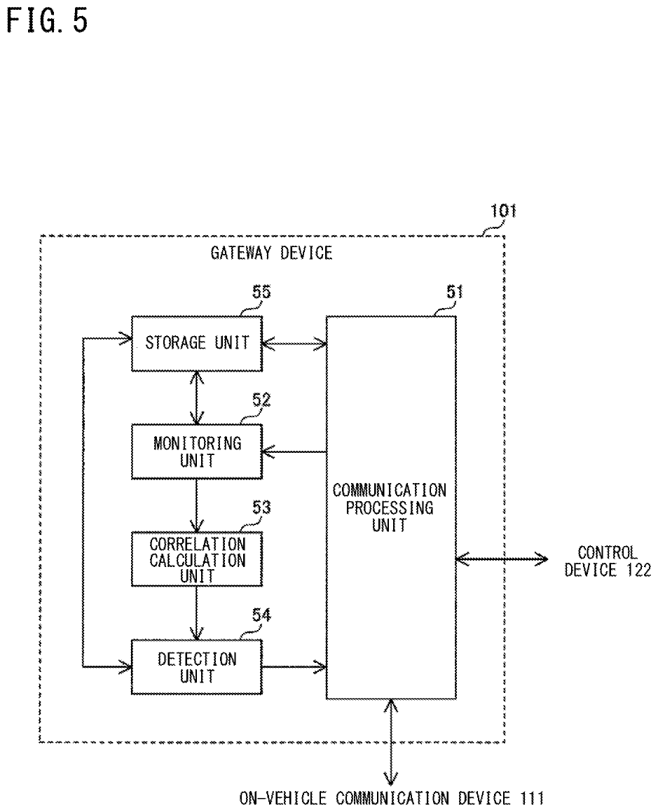

FIG. 5 shows a configuration of the gateway device in the on-vehicle communication system according to the embodiment of the present disclosure.

With reference to FIG. 5, the gateway device 101 includes a communication processing unit 51, a monitoring unit 52, a correlation calculation unit 53, a detection unit 54, and a storage unit 55. The storage unit 55 includes, for example, a volatile storage region and a nonvolatile storage region.

The communication processing unit 51 in the gateway device 101 performs a relay process. More specifically, upon receiving a message from a control device 122 via a corresponding bus 13, the communication processing unit 51 transmits the received message to another control device 122 via a corresponding bus 13.

The gateway device 101 functions as a detection device and detects an unauthorized message in the on-vehicle network 12 including a plurality of on-vehicle devices.

The gateway device 101 detects an unauthorized message in the on-vehicle network 12 in a detection cycle C, which is a predetermined cycle. The detection cycle C is set to an arbitrary appropriate value in accordance with an assumed unauthorized message, etc.

[Monitoring Unit]

The monitoring unit 52 monitors a transmission message in the on-vehicle network 12. More specifically, for example, the monitoring unit 52 monitors messages subjected to the relay process performed by the communication processing unit 51, and measures the value of the transmission interval of an event message to be detected (hereinafter also referred to as a target message) among messages to be monitored.

For example, the monitoring unit 52 measures a transmission interval of each target message in a first period and a transmission interval of each target message in a second period, which is a period different from the first period.

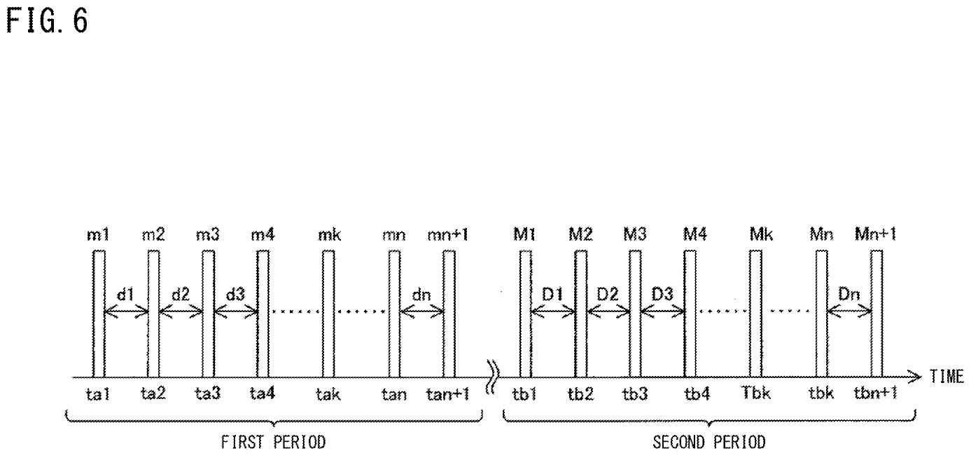

FIG. 6 shows an example of a distribution of reception times of target messages in the on-vehicle communication system according to the embodiment of the present disclosure. In FIG. 6, the horizontal axis represents time.

For example, the storage unit 55 stores, in the nonvolatile storage region, correspondence information indicating a correspondence relationship between the ID, and the content, transmission source, etc., of each event message. For example, the monitoring unit 52 obtains the ID of the target message (hereinafter also referred to as a target ID) from the storage unit 55.

For example, when the communication processing unit 51 has received a message, the monitoring unit 52 confirms the ID included in the message received by the communication processing unit 51. With reference to FIG. 6, when the confirmed ID matches the target ID, the monitoring unit 52 stores, into the volatile storage region of the storage unit 55, a reception time ta1 of the message received by the communication processing unit 51, i.e., a target message m1.

Then, when a new target message m2 including the target ID has been received by the communication processing unit 51, the monitoring unit 52 stores a reception time ta2 of the newly received target message m2 into, for example, the volatile storage region of the storage unit 55, and performs the following process. That is, the monitoring unit 52 sets, as a transmission interval dl of the target message, a reception interval calculated by subtracting the reception time ta1 from the reception time ta2, and stores the calculated transmission interval dl into, for example, the volatile storage region of the storage unit 55.

That is, the monitoring unit 52 subtracts, from a reception time tak of a target message mk, a reception time tak−1 of a target message mk−1 received immediately before the target message mk, thereby calculating a transmission interval dk−1. In this manner, the monitoring unit 52 measures respective transmission intervals dk of n+1 target messages mk in a period from the reception time ta1 to a reception time tan+1 (hereinafter, also referred to as a first period), thereby obtaining data of n transmission intervals dk. In this specification, it is assumed that k and n are each a positive integer and satisfy n>k.

Similarly, in a period (hereinafter, also referred to as a second period) from a reception time tb1, which is a time after a lapse of a predetermined time period from a reception time tan+1, to a reception time tbn+1, the monitoring unit 52 subtracts, from a reception time tbk of a target message Mk, a reception time tbk−1 of a target message Mk−1 received immediately before the target message Mk, thereby calculating a transmission interval Dk−1. In this manner, in the second period, the monitoring unit 52 measures respective transmission intervals Dk of n+1 target messages Mk, thereby obtaining data of n transmission intervals Dk.

Hereinafter, a transmission interval dk−1 calculated by subtracting a reception time tak−1 from a reception time tak will be referred to as a transmission interval dk corresponding to the reception time tak. In addition, a transmission interval Dk−1 calculated by subtracting a reception time tbk−1 from a reception time tbk will be referred to as a transmission interval Dk corresponding to the reception time tbk.

The monitoring unit 52 creates time series data of values of the transmission intervals dk of the target messages mk in the first period and time series data of the values of the transmission intervals Dk of the target messages Mk in the second period. For example, the monitoring unit 52 creates time series data in which the values of the transmission intervals dk of the target messages mk in the first period are arrayed in time series, and time series data in which the values of the transmission intervals Dk of the target messages Mk in the second period are arrayed in time series.

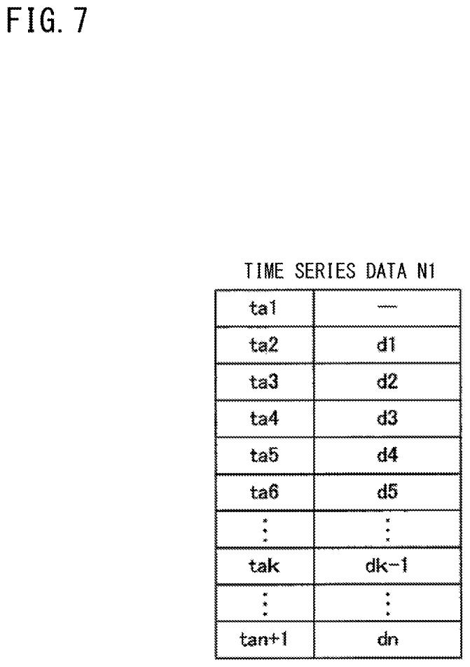

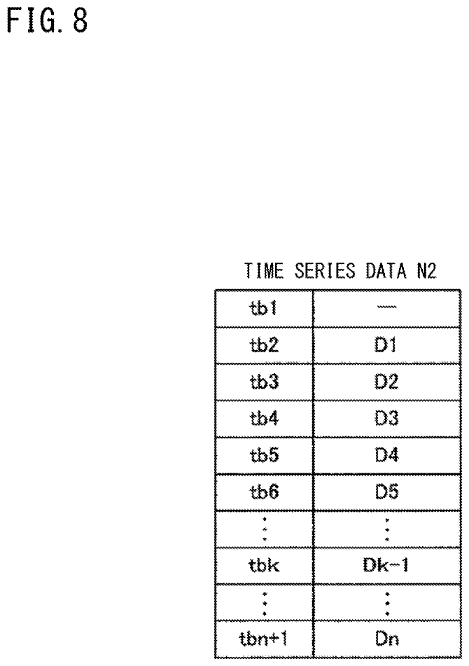

FIG. 7 and FIG. 8 each show an example of time series data of the transmission intervals of target messages in the on-vehicle communication system according to the embodiment of the present disclosure.

With reference to FIG. 7, for example, the monitoring unit 52 creates time series data N1 which is an array of the reception time tak and the transmission interval dk of each target message mk in the first period. With reference to FIG. 8, for example, the monitoring unit 52 creates time series data N2 which is an array of the reception time tbk and the transmission interval Dk of each target message Mk in the second period. The number of pieces of data of the transmission interval dk in the time series data N1 and the number of pieces of data of the transmission interval Dk in the time series data N2 are each n and the same.

The monitoring unit 52 performs, on the created time series data N1, N2, a sign reversing process of alternately reversing, along time series, the positive/negative sign of the value of each transmission interval dk, Dk, to create time series data Ns1, Ns2.

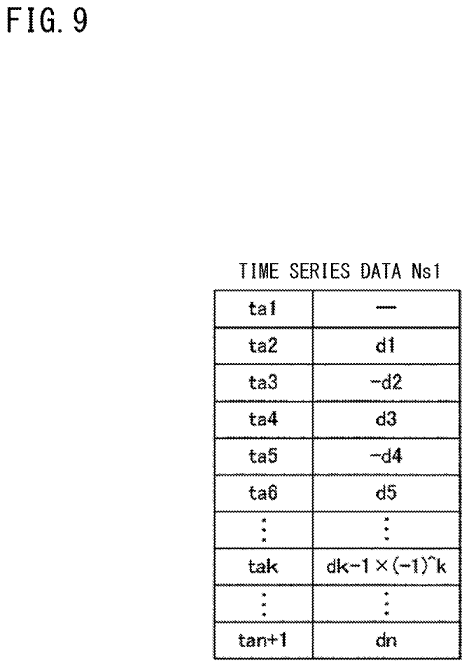

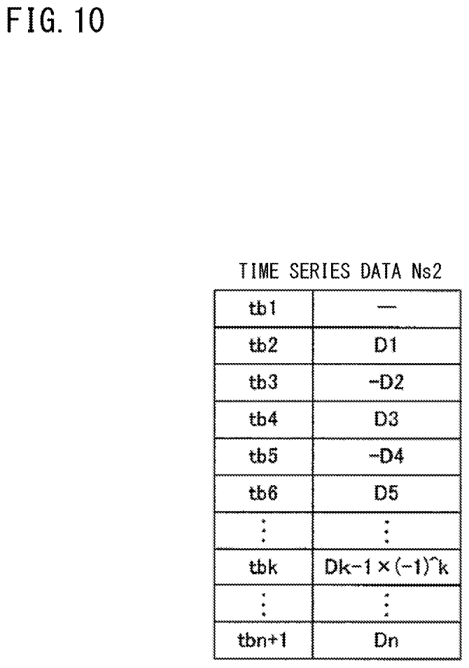

FIG. 9 and FIG. 10 each show an example of time series data having been subjected to the sign reversing process in the on-vehicle communication system according to the embodiment of the present disclosure.

With reference to FIG. 9, for example, the monitoring unit 52 multiplies the value of the transmission interval dk−1 corresponding to the reception time tak in the time series data N1 by (−1)\hat{ }k, thereby creating time series data Ns1 in which the positive/negative sign of the value of each transmission interval dk is alternately reversed along time series. With reference to FIG. 10, for example, the monitoring unit 52 multiplies the value of the transmission interval Dk−1 corresponding to the reception time tbk in the time series data N2 by (−1)\hat{ }k, thereby creating time series data Ns2 in which the positive/negative sign of the value of each transmission interval Dk is alternately reversed along time series. Here, “x\hat{ }y” means “x to the power of y”.

With reference to FIG. 9, for example, in the time series data Ns1, the value of the transmission interval dk−1 corresponding to the even number-th reception time tak along time series is a positive number, and the value of the transmission interval dk−1 corresponding to the odd number-th reception time tak is a negative number. With reference to FIG. 10, for example, in the time series data Ns2, the value of the transmission interval Dk−1 corresponding to the even number-th reception time tbk along time series is a positive number, and the value of the transmission interval Dk−1 corresponding to the odd number-th reception time tbk is a negative number. Although n is an odd number in the examples shown in FIG. 9 and FIG. 10, n may be an even number.

The monitoring unit 52 may create the time series data Ns1 by multiplying the value of the transmission interval dk−1 corresponding to the reception time tak in the time series data N1 by (−1)\hat{ }(k+1), and may create the time series data Ns2 by multiplying the value of the transmission interval Dk−1 corresponding to the reception time tbk in the time series data N2 by (−1)\hat{ }(k+1). That is, in the time series data Ns1, Ns2, the value of the transmission interval dk−1, Dk−1 corresponding to the even number-th reception time tak, tbk along time series may be a negative number, and the value of the transmission interval dk−1, Dk−1 corresponding to the odd number-th reception time tak, tbk may be a positive number.

The number of pieces of data of the transmission interval dk, Dk in the time series data Ns1, Ns2, i.e., a number of samples n (hereinafter, also referred to as a window size) of the transmission interval dk, Dk to be used in calculation of an autocorrelation coefficient r described later, can be set to an arbitrary appropriate value in accordance with an assumed unauthorized message or the like.

For example, the storage unit 55 stores setting information indicating a start timing of the first period, a start timing of the second period, a window size, and the like in the nonvolatile storage region. The monitoring unit 52 obtains the setting information from the storage unit 55 and creates time series data Ns1, Ns2 in accordance with the setting information obtained from the storage unit 55.

The monitoring unit 52 outputs the created time series data Ns1, Ns2 to the correlation calculation unit 53.

[Correlation Calculation Unit]

The correlation calculation unit 53 calculates a correlation between the time series data Ns1 in the first period and the time series data Ns2 in the second period, which have been created by the monitoring unit 52.

For example, the correlation calculation unit 53 calculates an autocorrelation coefficient r of the transmission interval of the target message by using: the difference between the value of each transmission interval in the time series data Ns1 and the average value of the values in the time series data Ns1, i.e., the values of all of the transmission intervals in the time series data Ns1; and the difference between the value of each transmission interval in the time series data Ns2 and the average value of the values in the time series data Ns2, i.e., the values of all of the transmission intervals in the time series data Ns2.

More specifically, upon receiving the time series data Ns1, Ns2 from the monitoring unit 52, the correlation calculation unit 53 calculates the average value of the transmission intervals dk in the time series data Ns1 and the average value of the transmission intervals Dk in the time series data Ns2. Then, the correlation calculation unit 53 calculates an autocorrelation coefficient r in accordance with the formula (1) below.

$$\begin{matrix}[ Math . 1 ] & \\ r = \frac{{\sum }_{i = 1}^{n} ( {x}_{i} - {μ}_{x} ) ( {y}_{i} - {μ}_{y} )}{\sqrt{{\sum }_{i = 1}^{n} {( {x}_{i} - {μ}_{x} )}^{2}} \sqrt{{\sum }_{i = 1}^{n} {( {y}_{i} - {μ}_{y} )}^{2}}} & ( 1 )\end{matrix}$$

Here, n is the number of pieces of data of the transmission interval in the time series data Ns1, Ns2. xᵢ is the i-th transmission interval in the time series data Ns1. yᵢ is the i-th transmission interval in the time series data Ns2. μₓ is the average value of the values of all of the transmission intervals in the time series data Ns1. μ_{y} is the average value of the values of all of the transmission intervals in the time series data Ns2.

The correlation calculation unit 53 outputs the calculated autocorrelation coefficient r to the detection unit 54.

[Detection Unit]

The detection unit 54 detects an unauthorized message on the basis of the correlation calculated by the correlation calculation unit 53.

More specifically, the detection unit 54 detects an unauthorized message on the basis of the autocorrelation coefficient r received from the correlation calculation unit 53.

For example, the storage unit 55 stores a threshold for the autocorrelation coefficient r in the nonvolatile storage region. The detection unit 54 obtains the threshold from the storage unit 55 and detects an unauthorized message on the basis of the autocorrelation coefficient r and the threshold obtained from the storage unit 55.

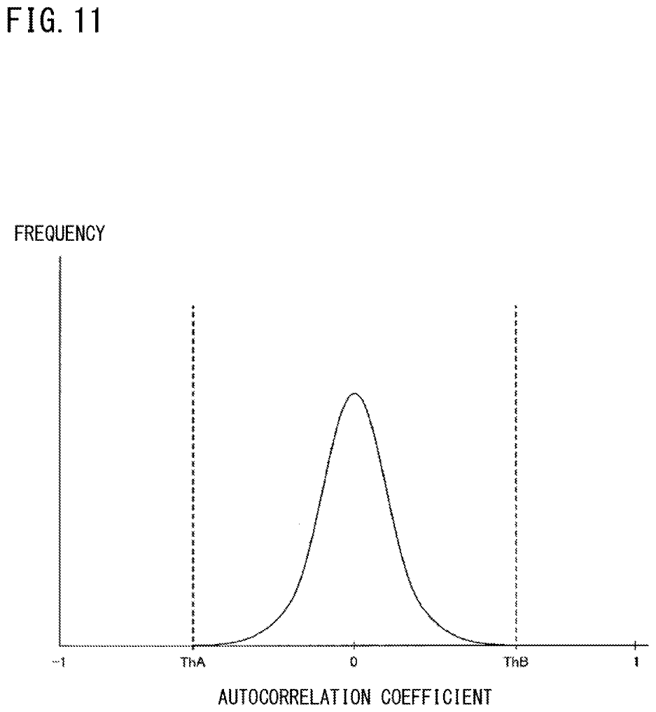

FIG. 11 shows an example of a frequency distribution of an autocorrelation coefficient of the transmission interval in the on-vehicle communication system according to the embodiment of the present disclosure. In FIG. 11, the vertical axis represents frequency and the horizontal axis represents autocorrelation coefficient. FIG. 11 shows a frequency distribution of the autocorrelation coefficient r in a case where all of the target messages are authorized event messages.

With reference to FIG. 11, the autocorrelation coefficient r takes a value of not less than −1 and not greater than 1. The closer to 1 the autocorrelation coefficient r is, the stronger the positive correlation between the time series data Ns1 and the time series data Ns2 is. The closer to −1 the autocorrelation coefficient r is, the stronger the negative correlation between the time series data Ns1 and the time series data Ns2 is.

When all of the target messages are authorized event messages (hereinafter, also referred to as authorized messages, the correlation between the time series data Ns1 and the time series data Ns2 is low, and the autocorrelation coefficient r takes a value close to 0.

Meanwhile, when a periodic unauthorized message is present among the target messages, the correlation between the time series data Ns1 and the time series data Ns2 is increased when compared with a case where all of the target messages are authorized messages, and the autocorrelation coefficient r takes a value close to −1 or 1.

Thus, the detection unit 54 detects an unauthorized message on the basis of, for example, a first threshold ThA being a negative number greater than −1 and a second threshold ThB being a positive number smaller than 1.

More specifically, for example, when the autocorrelation coefficient r is not less than the threshold ThA and not greater than the threshold ThB, the detection unit 54 determines that no unauthorized message is included in the plurality of target messages in the first period and the second period, and that all of the plurality of target messages are authorized messages.

Meanwhile, for example, when the autocorrelation coefficient r is smaller than the threshold ThA or greater than the threshold ThB, the detection unit 54 determines that an unauthorized message is present among a plurality of target messages in at least one of the first period and the second period.

The detection unit 54 outputs, to the communication processing unit 51, determination information indicating the determination result based on the autocorrelation coefficient r and the thresholds ThA, ThB.

When the determination information received from the detection unit 54 indicates that all of the target messages transmitted this time are authorized messages, the communication processing unit 51 transmits the target messages to the control device 122 of the transmission destination.

Meanwhile, when the determination information received from the detection unit 54 indicates that an unauthorized message is present among the plurality of target messages transmitted this time, the communication processing unit 51 performs the following process.

That is, the communication processing unit 51 records the plurality of target messages indicated by the determination information. In addition, the communication processing unit 51 transmits, to a higher-order device inside or outside the target vehicle, alarm information indicating that an unauthorized message is being transmitted in a bus 13.

Preferably, the threshold ThA, ThB is an appropriate value that allows accurate determination of whether or not an unauthorized message is present among target messages. For example, it is preferable that: with use of a gateway device 101 of a test vehicle of the same type as the target vehicle, a frequency distribution of an autocorrelation coefficient r calculated when all target messages are authorized messages is obtained in advance; and the threshold ThA, ThB is set such that the absolute value of the threshold ThA, ThB becomes smallest in a range where an FPR (False Positive Rate) becomes zero.

Here, FPR refers to a false positive rate and is represented as false positive/(false positive+true negative). True negative is the frequency at which an authorized message has been recognized as an authorized message, and false positive is the frequency at which an authorized message has been detected as an unauthorized message.

The thresholds ThA, ThB may be set such that the absolute values thereof are equal to each other, or may be set such that the absolute values are different from each other.

[Evaluation]

Sensitivity of the detection method for an unauthorized message performed in the on-vehicle communication system according to the embodiment of the present disclosure was evaluated in the following procedure.

Evaluation of the detection method for an unauthorized message was performed by measuring a TPR (True Positive Rate) in a case where the detection method according to the embodiment of the present disclosure (hereinafter, also referred to as a method A) was used, and a TPR in a case where a method for detecting an unauthorized message on the basis of the reception frequency of messages (hereinafter, also referred to as a method B) was used.

Here, TPR refers to true positive rate and is represented as true positive/(true positive+false negative). True positive is the frequency at which an unauthorized message has been detected as an unauthorized message, and false negative is the frequency at which an unauthorized message has been recognized as an authorized message.

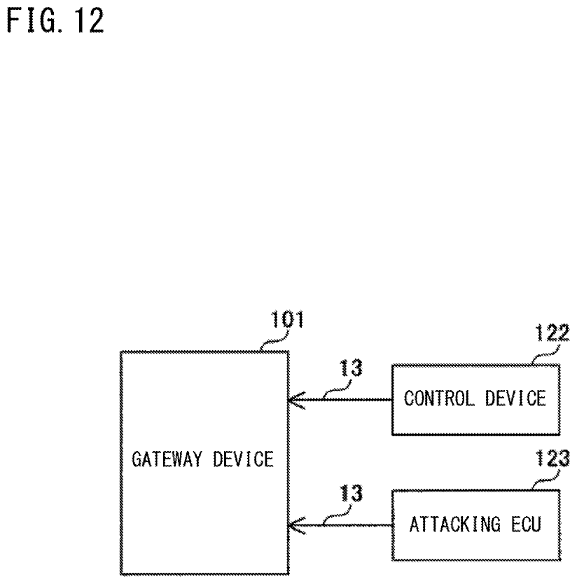

FIG. 12 shows an evaluation model used in the evaluation of the detection method for an unauthorized message in the on-vehicle communication system according to the embodiment of the present disclosure.

With reference to FIG. 12, a case in which an authorized message is transmitted from an authorized control device 122 to the gateway device 101 and an unauthorized message is transmitted from an attacking ECU 123 to the gateway device 101 is assumed.

In the evaluation model shown in FIG. 12, the control device 122 transmits an event message indicating a state of a headlight of a test vehicle to the gateway device 101. More specifically, when the state of the headlight has changed from a turned-on state to a turned-off state, or from a turned-off state to a turned-on state, the control device 122 generates an event message indicating that the state of the headlight has changed, and transmits the event message to the gateway device 101.

Authorized event messages used in this evaluation were generated as follows. That is, turning-on and turning-off of a headlight was repeatedly switched as fast as possible by operating a headlight switch of the test vehicle, whereby event messages (hereinafter, also referred to as evaluation event messages) each indicating a state of the headlight was generated in the control device 122.

[Determination of Threshold]

Thresholds ThA, ThB in the method A were determined as follows. That is, in a state where evaluation event messages were transmitted from the control device 122 to the gateway device 101, a frequency distribution of an autocorrelation coefficient r when the window size was set to 10 was obtained. Then, the thresholds ThA, ThB were set such that the absolute values of the thresholds ThA, ThB become smallest in a range where FPR becomes zero. In similar manners, thresholds ThA, ThB when the window size was set to 20, and thresholds ThA, ThB when the window size was set to 20 were set.

Specifically, the threshold when the window size was set to 10 was set to ±0.95, the threshold when the window size was set to 20 was set to ±0.92, and the threshold when the window size was set to 30 was set to ±0.90.

A threshold ThC in the method B was determined as follows. That is, since the transmission frequency of the evaluation event messages from the control device 122 to the gateway device 101 was 13 times/0.01 seconds, the threshold ThC for the number of times of message reception per 0.01 seconds was set to 13 in the method B such that the threshold ThC becomes smallest in a range where FPR becomes zero.

That is, in this evaluation, in the method B, when the number of times of message reception per 0.01 seconds exceeds the threshold ThC to be not less than 14 times, the gateway device 101 determines that an unauthorized message is present among the received messages.

[Evaluation Result]

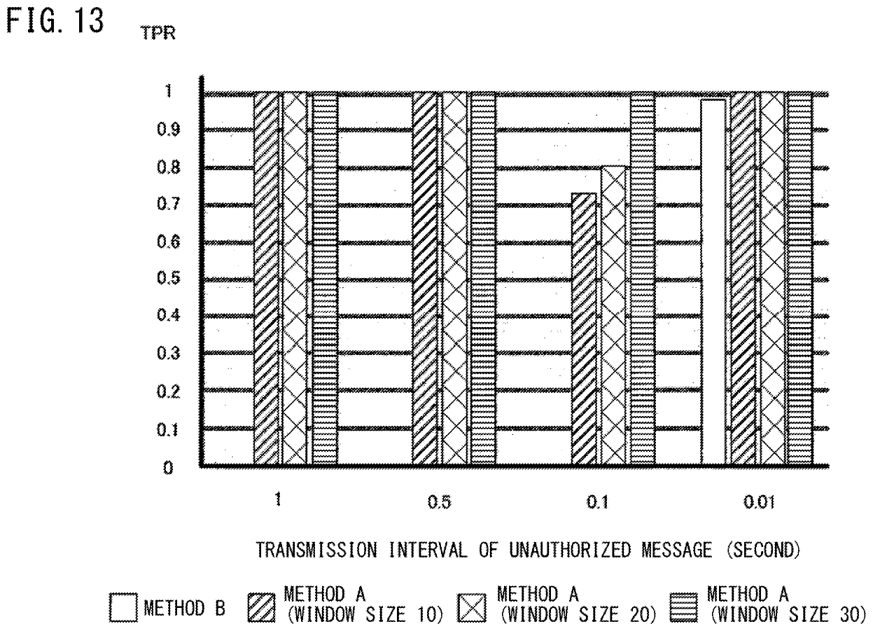

FIG. 13 shows an evaluation result of sensitivity of the detection method for an unauthorized message in the on-vehicle communication system according to the embodiment of the present disclosure. In FIG. 13, the vertical axis represents TPR.

FIG. 13 shows detection sensitivity, i.e., TPR, of an unauthorized message by the gateway device 101 in a case where a pseudo unauthorized message was transmitted from the attacking ECU 123 to the gateway device 101 while authorized event messages were transmitted from the control device 122 to the gateway device 101. As the pseudo unauthorized message, a periodic message transmitted in a 1-second interval, a 0.5-second interval, a 0.1-second interval, or a 0.01-second interval was used.

With reference to FIG. 13, in the method B, a high TPR was exhibited when the transmission interval of the unauthorized message was set to 0.01 seconds. However, when the transmission interval of the unauthorized message was set to 0.1 seconds, when the transmission interval of the unauthorized message was set to 0.5 seconds, and when the transmission interval of the unauthorized message was set to 1 second, TPR became zero. This means that the unauthorized message that should be detected was not able to be detected.

In contrast, in the method A, in each of cases when the transmission interval of the unauthorized message was set to 0.01 seconds, 0.1 seconds, 0.5 seconds, and 1 second, a high TPR was exhibited. This means that the unauthorized message that should be detected was able to be appropriately detected.

[Implementation Example of Devices]

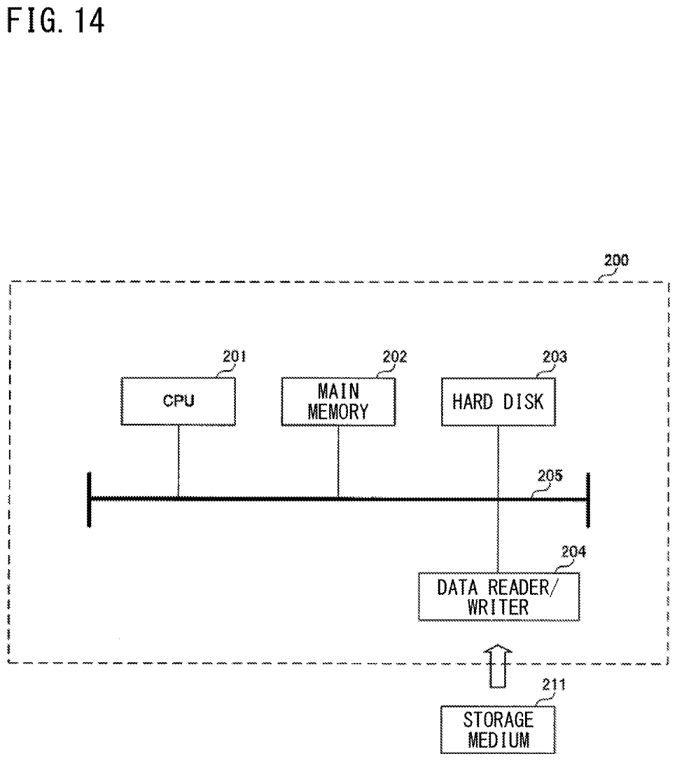

FIG. 14 shows a configuration of devices in the on-vehicle communication system according to the embodiment of the present disclosure. In the following, each of the devices such as the gateway device 101, the on-vehicle communication device 111, and the control device 122 in the on-vehicle communication system 301 is also referred to as a device 200.

With reference to FIG. 14, each device 200 in the on-vehicle communication system 301 includes: a CPU 201 as an arithmetic processing unit; a main memory 202; a hard disk 203; and a data reader/writer 204. These components are connected so as to be able to perform data communication with each other via a bus 205.

The CPU 201 deploys, on the main memory 202, a program stored in the hard disk 203 and executes the program in a predetermined order to perform various arithmetic operations. The main memory 202 is typically a volatile storage device such as a DRAM (Dynamic Random Memory), and holds data and the like indicating various arithmetic processing results in addition to the program read out from the hard disk 203. The hard disk 203 is a nonvolatile magnetic storage device, and stores various set values in addition to the program executed by the CPU 201. The program installed in the hard disk 203 is distributed in a state of being stored in a storage medium 211. In addition to the hard disk 203, or instead of the hard disk 203, a semiconductor storage device such as a flash memory may be adopted.

The data reader/writer 204 serves for data transmission between the CPU 201 and the storage medium 211. That is, the storage medium 211 is distributed in a state where a program and the like to be executed in the device 200 are stored, and the data reader/writer 206 reads out the program from the storage medium 211. The storage medium 211 is, for example, a general-purpose semiconductor storage device such as CF (Compact Flash) and SD (Secure Digital), a magnetic storage medium such as a flexible disk, or an optical storage medium such as a CD-ROM (Compact Disk Read Only Memory) or a DVD (Digital Versatile Disc)-ROM.

[Operation]

Each device 200 in the on-vehicle communication system 301 includes a computer including a memory such as the hard disk 203. An arithmetic processing unit such as the CPU 201 in the computer reads out, from the memory, a program including a part or all of the steps in the flow chart below, and executes the program. Programs for the plurality of devices 200 can be installed from outside. The programs for the plurality of devices 200 are each distributed in a state of being stored in the storage medium 211.

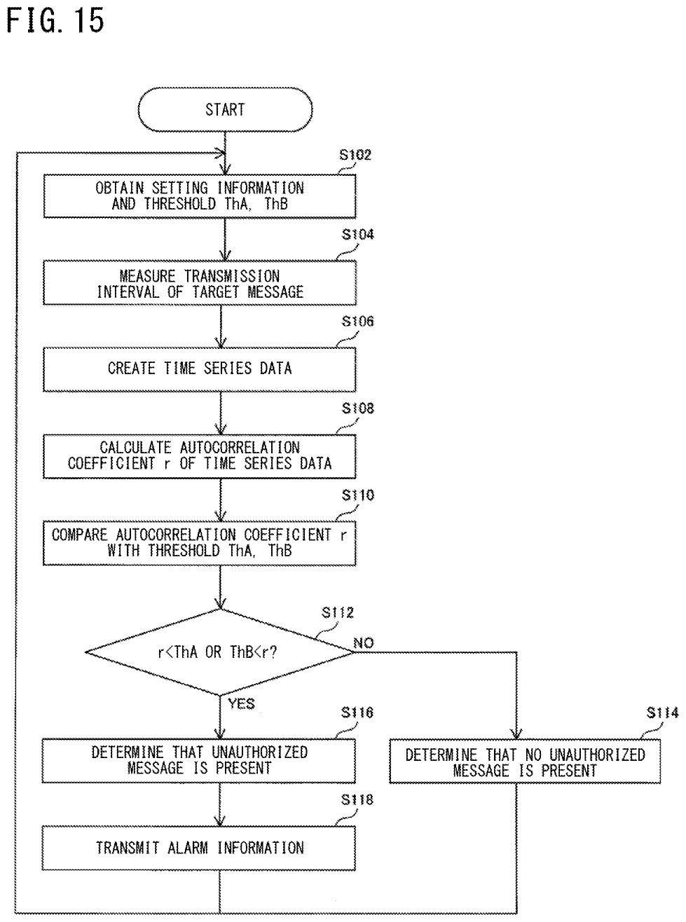

FIG. 15 is a flow chart describing an operation procedure according to which the gateway device of the embodiment of the present disclosure performs detection of an unauthorized message.

With reference to FIG. 15, first, in accordance with a predetermined timing based on a detection cycle C, the gateway device 101 obtains setting information and thresholds ThA, ThB from the storage unit 55 (step S102).

Next, on the basis of the obtained setting information, the gateway device 101 measures transmission intervals dk of target messages mk in the first period and transmission intervals Dk of target messages Mk in the second period (step S104).

Next, on the basis of the measurement results of the transmission intervals dk, Dk of the target messages mk, Mk, the gateway device 101 creates time series data Ns1 and time series data Ns2 (step S106).

Next, the gateway device 101 calculates an autocorrelation coefficient r by using the time series data Ns1 and the time series data Ns2 (step S108).

Next, the gateway device 101 detects an unauthorized message on the basis of the autocorrelation coefficient r. More specifically, first, the gateway device 101 compares the calculated autocorrelation coefficient r with the thresholds ThA, ThB (step S110).

Next, for example, when the calculated autocorrelation coefficient r is not less than the threshold ThA and not greater than the threshold ThB (NO in step S112), the gateway device 101 determines that no unauthorized message is present among each of the target messages mk, Mk in the first period and the second period (step S114).

Next, in accordance with a new timing based on the detection cycle C, the gateway device 101 performs obtainment of setting information and thresholds ThA, ThB (step S102), measurement of transmission intervals dk, Dk (step S104), and the like.

Meanwhile, for example, when the calculated autocorrelation coefficient r is less than the threshold ThA or greater than the threshold ThB (YES in step S112), the gateway device 101 determines that an unauthorized message is present among the target messages mk, Mk in at least one of the first period and the second period (step S116).

Next, the gateway device 101 transmits, to a higher-order device inside or outside the target vehicle, alarm information indicating that an unauthorized message is being transmitted (step S118).

Next, in accordance with a new timing based on the detection cycle C, the gateway device 101 performs obtainment of setting information and thresholds ThA, ThB (step S102), measurement of transmission intervals dk, Dk (step S104), and the like.

In the on-vehicle communication system according to the embodiment of the present disclosure, the gateway device 101 detects an unauthorized message in the on-vehicle network 12. However, the present disclosure is not limited thereto. In the on-vehicle communication system 301, a detection device different from the gateway device 101 may detect an unauthorized message in the on-vehicle network 12.

In the gateway device 101 according to the embodiment of the present disclosure, the monitoring unit 52 measures the transmission intervals dk, Dk on the basis of the reception times tak, tbk of the target messages mk, Mk. However, the present disclosure is not limited thereto. For example, the monitoring unit 52 may obtain the transmission times of the target messages mk, Mk, and measure the transmission intervals dk, Dk on the basis of the obtained transmission times.

In the on-vehicle communication system according to the embodiment of the present disclosure, the gateway device 101 functioning as a detection device is directly connected to a bus 13. However, the present disclosure is not limited thereto.

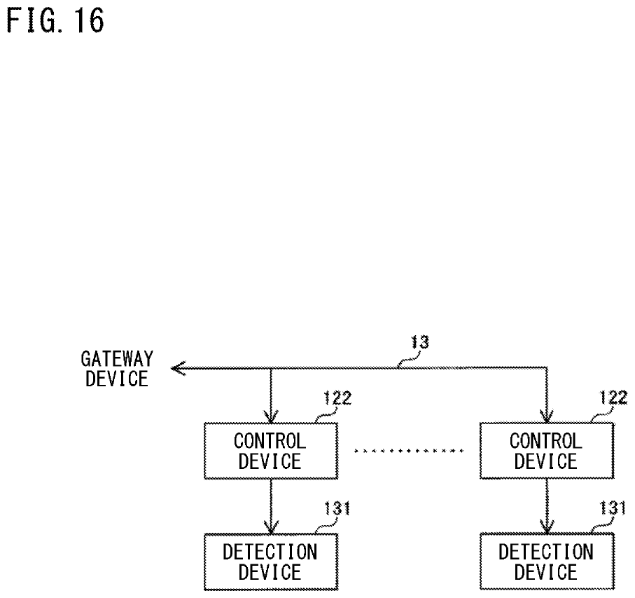

FIG. 16 shows an example of a connection topology of an on-vehicle network according to the embodiment of the present disclosure.

With reference to FIG. 16, a detection device 131 may be connected to a bus 13 via an on-vehicle device, e.g., a control device 122. In this case, for example, the detection device 131 detects an unauthorized message transmitted to the bus 13, by monitoring a message transmitted/received by the on-vehicle device.

In the example shown in FIG. 16, for example, a monitoring unit 52 of the detection device 131 obtains transmission times of messages transmitted by the control device 122, measures transmission intervals dk, Dk on the basis of the obtained transmission times, and creates time series data Ns1, Ns2 of the measured transmission intervals dk, Dk.

In the gateway device 101 according to the embodiment of the present disclosure, messages transmitted/received between control devices 122 are targets for detection of an unauthorized message performed by the detection unit 54. However, the present disclosure is not limited thereto. Messages transmitted/received between a control device 122 and an on-vehicle communication device 111 and messages transmitted/received between on-vehicle communication devices 111 may be targets for detection of an unauthorized message performed by the detection unit 54.

In the gateway device 101 according to the embodiment of the present disclosure, the monitoring unit 52 creates time series data Ns1, Ns2 that have the same number of samples of the transmission interval dk, Dk. However, the present disclosure is not limited thereto. The monitoring unit 52 may create time series data Ns1, Ns2 that have different numbers of samples of the transmission interval dk, Dk. In this case, preferably, the correlation calculation unit 53 resamples time series data of either one of the time series data Ns1, Ns2 such that the numbers of samples of the transmission interval dk, Dk in the time series data Ns1, Ns2 are equal to each other, and calculates an autocorrelation coefficient r by using the resampled time series data.

In the gateway device 101 according to the embodiment of the present disclosure, the monitoring unit 52 creates time series data Ns2 of the transmission interval Dk in the second period that starts at a time tb1 after a lapse of the first period. However, the present disclosure is not limited thereto. The monitoring unit 52 may create time series data Ns2 of the transmission interval Dk in a second period that starts from a time in the first period. That is, a part of the first period and a part of the second period may overlap each other.

In the gateway device 101 according to the embodiment of the present disclosure, as a process of detecting an unauthorized message, the detection unit 54 determines whether or not an unauthorized message is present among a plurality of the target messages mk, Mk in at least one of the first period and the second period. However, the present disclosure is not limited thereto. As the process of detecting an unauthorized message, the detection unit 54 may calculate a probability of an unauthorized message being present among the target messages mk, Mk.

In the gateway device 101 according to the embodiment of the present disclosure, the correlation calculation unit 53 calculates an autocorrelation coefficient r of the time series data N1, N2 in accordance with formula (1). However, the present disclosure is not limited thereto. The correlation calculation unit 53 may calculate a correlation of the time series data N1, N2 in accordance with another formula other than formula (1).

In the gateway device 101 according to the embodiment of the present disclosure, with respect to the time series data N1, N2, the monitoring unit 52 performs a sign reversing process of alternately reversing, along time series, the positive/negative sign of the value of each transmission interval dk, Dk, to create time series data Ns1, Ns2. However, the present disclosure is not limited thereto. A configuration may be adopted in which: without performing the sign reversing process, the monitoring unit 52 outputs time series data N1, N2 to the correlation calculation unit 53; the correlation calculation unit 53 calculates an autocorrelation coefficient r of the time series data N1, N2; and the detection unit 54 detects an unauthorized message on the basis of the autocorrelation coefficient r.

In the gateway device 101 according to the embodiment of the present disclosure, the monitoring unit 52 creates time series data N1 and time series data N2, and performs a sign reversing process on the created time series data N1, N2, to create time series data Ns1, Ns2. However, the present disclosure is not limited thereto. The monitoring unit 52 may multiply a value obtained by subtracting a reception time tak−1 from a reception time tak by (−1)\hat{ }k, to create time series data Ns1 without creating time series data N1. The monitoring unit 52 may multiply a value obtained by subtracting a reception time tbk−1 from a reception time tbk by (−1)\hat{ }k, to create time series data Ns2 without creating time series data N2.

In the gateway device 101 according to the embodiment of the present disclosure, the detection unit 54 detects an unauthorized message on the basis of an autocorrelation coefficient r calculated by the correlation calculation unit 53 and two thresholds ThA, ThB. However, the present disclosure is not limited thereto. The detection unit 54 may detect an unauthorized message on the basis of an autocorrelation coefficient r, and one, or three or more thresholds.

Meanwhile, in the on-vehicle network system according to PATENT LITERATURE 1, in order to detect an unauthorized data frame on the basis of a specific identifier, a providing unit that provides the specific identifier to an event-driven data frame is required in the transmission-side electronic control unit, and a verifying unit that verifies the specific identifier is required in the reception-side electronic control unit. This results in a complicated configuration of the on-vehicle network system.

In contrast, the detection device according to the embodiment of the present disclosure detects an unauthorized message in the on-vehicle network 12 including a plurality of on-vehicle devices. The monitoring unit 52 monitors target messages in the on-vehicle network 12, and creates time series data N1, Ns1 of transmission intervals dk of target messages mk in the first period, and time series data N2, Ns2 of transmission intervals Dk of target messages Mk in the second period. The correlation calculation unit 53 calculates an autocorrelation coefficient r by using the time series data N1, Ns1 and the time series data N2, Ns2 created by the monitoring unit 52. Then, the detection unit 54 detects an unauthorized message on the basis of the autocorrelation coefficient r calculated by the correlation calculation unit 53.

For example, when the target messages mk, Mk in the first period and the second period are authorized messages that are non-periodically transmitted, the correlation between the time series data N1, Ns1 and the time series data N2, Ns2 is low. Meanwhile, when an unauthorized message that is periodically transmitted is present among the target messages mk, Mk in the first period and the second period, periodicity of the target messages mk, Mk is increased, and thus, the correlation between the time series data N1, Ns1 and the time series data N2, Ns2 is increased. In the case of the detection device according to the embodiment of the present disclosure, an autocorrelation coefficient r calculated by use of the time series data of the transmission intervals dk, Dk is focused on, and an unauthorized message is detected on the basis of the autocorrelation coefficient r. Therefore, when compared with a configuration in which an unauthorized message is detected on the basis of the reception frequency of messages, an unauthorized message mixed among non-periodically transmitted authorized messages can be accurately detected.

Therefore, the detection device according to the embodiment of the present disclosure can accurately detect an unauthorized message in the on-vehicle network, with a simple configuration.

In the detection device according to the embodiment of the present disclosure, the monitoring unit 52 creates the time series data Ns1 and the time series data Ns2 in which the positive/negative sign of the values of the transmission intervals dk, Dk is alternately reversed along time series. The correlation calculation unit 53 calculates an autocorrelation coefficient r by using the difference between each transmission interval dk of the time series data Ns1 created by the monitoring unit 52, and the average value of the transmission intervals dk, and the difference between each transmission interval Dk of the time series data Ns2 created by the monitoring unit 52 and the average value of the transmission intervals Dk.

When unauthorized messages are periodically transmitted at a high frequency, each transmission interval dk, Dk of the target message mk, Mk becomes close to an equal interval, whereby the difference between each transmission interval dk, Dk and the average value of the transmission intervals dk, Dk is decreased. As a result, it may become difficult to accurately calculate, in a CPU or the like, an autocorrelation coefficient r by using the time series data N1, N2. In contrast, in a configuration in which time series data Ns1, Ns2 in which the positive/negative sign of the value of each transmission interval dk, Dk is alternately reversed along time series is created, and the difference between each transmission interval dk of the time series data Ns1 and the average value of the transmission intervals dk, and the difference between each transmission interval Dk of the time series data Ns2 and the average value of the transmission intervals Dk are used to calculate an autocorrelation coefficient r, the autocorrelation coefficient r can be accurately calculated by use of the time series data Ns1, Ns2 even when unauthorized messages are periodically transmitted at a high frequency. Accordingly, an unauthorized message can be detected with high accuracy on the basis of the autocorrelation coefficient r.

In the detection device according to the embodiment of the present disclosure, the detection unit 54 detects an unauthorized message when the autocorrelation coefficient r calculated by the correlation calculation unit 53 is smaller than the threshold ThA being a negative number greater than −1, or is greater than the threshold ThB being a positive number smaller than 1.

With this configuration, an unauthorized message can be accurately detected on the basis of, for example, the autocorrelation coefficient r calculated by use of the time series data N1, N2 and the thresholds ThA, ThB set to appropriate values in advance. In addition, an unauthorized message can be accurately detected on the basis of, for example, the autocorrelation coefficient r calculated by use of the time series data Ns1, Ns2 in which the positive/negative sign of the value of each transmission interval dk, Dk is alternately reversed along time series, and the thresholds ThA, ThB set to appropriate values in advance.

The gateway device 101 according to the embodiment of the present disclosure relays messages between on-vehicle devices in the on-vehicle network 12. The monitoring unit 52 monitors target messages in the on-vehicle network 12, and creates time series data N1, Ns1 of transmission intervals dk of target messages mk in the first period, and time series data N2, Ns2 of transmission intervals Dk of target messages Mk in the second period. The correlation calculation unit 53 calculates an autocorrelation coefficient r by using the time series data N1, Ns1 and the time series data N2, Ns2 created by the monitoring unit 52. Then, the detection unit 54 detects an unauthorized message in the on-vehicle network 12 on the basis of the autocorrelation coefficient r calculated by the correlation calculation unit 53.

For example, when the target messages mk, Mk in the first period and the second period are authorized messages that are non-periodically transmitted, the correlation between the time series data N1, Ns1 and the time series data N2, Ns2 is low. Meanwhile, when an unauthorized message that is periodically transmitted is present among the target messages mk, Mk in the first period and the second period, periodicity of the target messages mk, Mk is increased, and thus, the correlation between the time series data N1, Ns1 and the time series data N2, Ns2 is increased. In the case of the gateway device according to the embodiment of the present disclosure, an autocorrelation coefficient r calculated by use of the time series data of the transmission intervals dk, Dk is focused on, and an unauthorized message is detected on the basis of the autocorrelation coefficient r. Therefore, when compared with a configuration in which an unauthorized message is detected on the basis of the reception frequency of messages, an unauthorized message mixed among non-periodically transmitted authorized messages can be accurately detected.

Therefore, in the gateway device 101 according to the embodiment of the present disclosure, an unauthorized message in the on-vehicle network can be accurately detected with a simple configuration.

In a detection method according to the embodiment of the present disclosure, first, the detection device monitors target messages in the on-vehicle network 12, and creates time series data N1, Ns1 of transmission intervals dk of target messages mk in the first period and time series data N2, Ns2 of transmission intervals Dk of target messages Mk in the second period. Next, the detection device calculates an autocorrelation coefficient r by using the time series data N1, Ns1 and the time series data N2, Ns2 that have been created. Next, the detection device detects an unauthorized message on the basis of the calculated autocorrelation coefficient r.

For example, when the target messages mk, Mk in the first period and the second period are authorized messages that are non-periodically transmitted, the correlation between the time series data N1, Ns1 and the time series data N2, Ns2 is low. Meanwhile, when an unauthorized message that is periodically transmitted is present among the target messages mk, Mk in the first period and the second period, periodicity of the target messages mk, Mk is increased, and thus, the correlation between the time series data N1, Ns1 and the time series data N2, Ns2 is increased. In the case of the detection method according to the embodiment of the present disclosure, an autocorrelation coefficient r calculated by use of the time series data of the transmission intervals dk, Dk is focused on, and an unauthorized message is detected on the basis of the autocorrelation coefficient r. Therefore, when compared with a configuration in which an unauthorized message is detected on the basis of the reception frequency of messages, an unauthorized message mixed among non-periodically transmitted authorized messages can be accurately detected.

Therefore, the detection method according to the embodiment of the present disclosure can accurately detect an unauthorized message in the on-vehicle network, with a simple configuration.

In a detection method according to the embodiment of the present disclosure, first, the gateway device 101 monitors target messages in the on-vehicle network 12, and creates time series data N1, Ns1 of transmission intervals dk of target messages mk in the first period and time series data N2, Ns2 of transmission intervals Dk of target messages Mk in the second period. Next, the gateway device 101 calculates an autocorrelation coefficient r by using the time series data N1, Ns1 and the time series data N2, Ns2 that have been created. Next, the gateway device 101 detects an unauthorized message in the on-vehicle network 12 on the basis of the calculated autocorrelation coefficient r.

For example, when the target messages mk, Mk in the first period and the second period are authorized messages that are non-periodically transmitted, the correlation between the time series data N1, Ns1 and the time series data N2, Ns2 is low. Meanwhile, when an unauthorized message that is periodically transmitted is present among the target messages mk, Mk in the first period and the second period, periodicity of the target messages mk, Mk is increased, and thus, the correlation between the time series data N1, Ns1 and the time series data N2, Ns2 is increased. In the case of the detection method according to the embodiment of the present disclosure, an autocorrelation coefficient r calculated by use of the time series data of the transmission intervals dk, Dk is focused on, and an unauthorized message is detected on the basis of the autocorrelation coefficient r. Therefore, when compared with a configuration in which an unauthorized message is detected on the basis of the reception frequency of messages, an unauthorized message mixed among non-periodically transmitted authorized messages can be accurately detected.

Therefore, the detection method according to the embodiment of the present disclosure can accurately detect an unauthorized message in the on-vehicle network, with a simple configuration.

The above embodiment is merely illustrative in all aspects and should not be recognized as being restrictive. The scope of the present disclosure is defined by the scope of the claims rather than by the description above, and is intended to include meaning equivalent to the scope of the claims and all modifications within the scope.

The above description includes the features in the additional notes below.

[Additional Note 1]

A detection device configured to detect an unauthorized message in an on-vehicle network including a plurality of on-vehicle devices, the detection device comprising:

a monitoring unit configured to monitor transmission messages in the on-vehicle network, and configured to create first time series data that is time series data of values of transmission intervals of the transmission messages in a first period and in which a positive/negative sign of the value of each transmission interval is alternately reversed along time series, and second time series data that is time series data of values of transmission intervals of the transmission messages in a second period and in which a positive/negative sign of the value of each transmission interval is alternately reversed along time series;

a correlation calculation unit configured to calculate an autocorrelation coefficient of the transmission interval, by using the first time series data and the second time series data that have been created by the monitoring unit; and

a detection unit configured to determine whether or not the unauthorized message is present among the corresponding transmission messages, on the basis of the autocorrelation coefficient calculated by the correlation calculation unit.

[Additional Note 2]

A gateway device configured to relay messages between on-vehicle devices in an on-vehicle network, the gateway device comprising:

a monitoring unit configured to monitor transmission messages in the on-vehicle network, and configured to create first time series data that is time series data of values of transmission intervals of the transmission messages in a first period and in which a positive/negative sign of the value of each transmission interval is alternately reversed along time series, and second time series data that is time series data of values of transmission intervals of the transmission messages in a second period and in which a positive/negative sign of the value of each transmission interval is alternately reversed along time series;

a correlation calculation unit configured to calculate an autocorrelation coefficient of the transmission interval, by using the first time series data and the second time series data that have been created by the monitoring unit; and

a detection unit configured to determine whether or not an unauthorized message is present among the corresponding transmission messages, on the basis of the autocorrelation coefficient calculated by the correlation calculation unit.

### REFERENCE SIGNS LIST

12 on-vehicle network
13, 14 bus
51 communication processing unit
52 monitoring unit
53 correlation calculation unit
54 detection unit
55 storage unit
101 gateway device
111 on-vehicle communication device
112 port
121 bus connection device group
122 control device
131 detection device
301 on-vehicle communication system

1. A detection device configured to detect whether or not an unauthorized message in an on-vehicle network including a plurality of on-vehicle devices is present, the detection device comprising:
a monitoring unit configured to monitor transmission messages in the on-vehicle network and configured to create first time series data being time series data of values of transmission intervals of the transmission messages in a first period and second time series data being time series data of values of transmission intervals of the transmission messages in a second period;
a correlation calculation unit configured to calculate a correlation between the first time series data and the second time series data that have been created by the monitoring unit; and
a detection unit configured to detect whether or not the unauthorized message is present, on the basis of the correlation calculated by the correlation calculation unit.

2. The detection device according to claim 1, wherein
the monitoring unit creates the first time series data and the second time series data in each of which a positive/negative sign of the value of each transmission interval is alternately reversed along time series, and
the correlation calculation unit calculates the correlation by using a difference between the value of each transmission interval and an average value of the values of the transmission intervals in the first time series data created by the monitoring unit, and a difference between the value of each transmission interval and an average value of the values of the transmission intervals in the second time series data created by the monitoring unit.

3. The detection device according to claim 1, wherein
the detection unit determines that the unauthorized message is present among the corresponding transmission messages, when the correlation calculated by the correlation calculation unit is smaller than a first threshold being a negative number greater than −1, or is greater than a second threshold being a positive number smaller than 1.

4. The detection device according to claim 1, wherein
the detection device is a gateway device configured to relay messages between the on-vehicle devices.

5. A detection method to be performed in a detection device configured to detect whether or not an unauthorized message in an on-vehicle network including a plurality of on-vehicle devices is present, the detection method comprising the steps of:
monitoring transmission messages in the on-vehicle network and creating first time series data being time series data of values of transmission intervals of the transmission messages in a first period and second time series data being time series data of values of transmission intervals of the transmission messages in a second period;
calculating a correlation between the first time series data and the second time series data that have been created; and
detecting whether or not the unauthorized message is present, on the basis of the calculated correlation.

6. (canceled)

7. A non-transitory computer readable storage medium storing a detection program to be used in a detection device configured to detect whether or not an unauthorized message in an on-vehicle network including a plurality of on-vehicle devices is present, the detection program causing a computer to function as:
a monitoring unit configured to monitor transmission messages in the on-vehicle network, and configured to create first time series data being time series data of values of transmission intervals of the transmission messages in a first period and second time series data being time series data of values of transmission intervals of the transmission messages in a second period;
a correlation calculation unit configured to calculate a correlation between the first time series data and the second time series data that have been created by the monitoring unit; and
a detection unit configured to detect whether or not the unauthorized message is present, on the basis of the correlation calculated by the correlation calculation unit.

8. (canceled)
